(19) United States
(12) Patent Application Publication
(10) Pub. No.: US 2010/0005910 A1
(43) Pub. Date: Jan. 14, 2010

(54) BIO-DEGRADABILITY TESTING KIT

(75) Inventor: Leigh Melanie Cranley, Leicester (GB)

Correspondence Address: YOUNG BASILE, 3001 WEST BIG BEAVER ROAD, SUITE 624, TROY, MI, 48084, US

(73) Assignee: INVICTA PLASTICS LIMITED, Leicester, UK (GB)

(21) Appl. No.: 12/446,129

(22) PCT Filed: Oct. 18, 2007
(86) PCT No.: PCT/GB2007/003984

§ 371 Date: Aug. 10, 2009

(30) Foreign Application Priority Data
Oct. 18, 2006 (GB) 0620690.8
Nov. 4, 2006 (GB) 0621991.9

(51) Int. Cl. B01L 3/00; G01N 1/00

(52) U.S. Cl. 73/864.91; 73/863

(57) ABSTRACT

This invention relates to a kit to enable the bio-degradability of a material to be observed. The kit includes: at least one environmental vessel formed from a non bio-degradable material having an opening that can be covered with a scalable lid for loading of the vessel, which vessel includes means so that the vessel can be sealed or ventilated if desired; at least one sample of a material to be tested. The sample to be tested can be located in the vessel and tested under the influence of a particular environment, which environment may be ventilated if desired.

This invention relates to a kit to enable the environmental aspects and considerations of materials to be compared and assessed, and, more particularly, the biodegradability.

Over recent years we have all become more environmentally aware. The various considerations and effects of pollution on our lives are in the public eye with news events and world conferences, more often than not concerning global warming. This has made the world in general more environmentally conscious and aware of the effects on the environment of our living style.

The general public has adapted to the position, and tried to adapt to ease the burden of pollution on our environment, for example, recycling, etc. However the major effects of pollution are not incurred at this level, they are produced at the industrial level and relate to the production of materials or products. At present the general public does not have the power to influence manufacturers choices because there are no real alternatives to their products available in the marketplace. Further, in a majority of instances there are viable alternatives available to the manufacturer these are not adopted because there is no real effective driving force encouraging them to do so. Therefore they are not prepared to invest the small amounts of money needed to get the alternative into the market place.

One example of this is polymers. Over recent years society has eagerly adopted plastics into the home, either as direct product or as packaging for the products we buy. Plastics have replaced more traditional materials in certain instances for example:
the old traditional glass milk bottle, recycled both as a product and then as the material, has been replaced by plastic bottles or plastic coated cartons that are thrown away;
soap powder comes with a plastic filling scoop that is discarded when the packet is finished;
metal paint cans are now plastic and designed to be discarded when used; and
products are commonly wrapped in plastic film and not cellophane or other traditional materials.

There has been an increasing rise in the amount of plastic used in day-to-day living and with it there is a tendency for that material to be simply thrown away and so end up on one of the landfill sites about the country to be recycled into the environment by natural means. That in itself, is not a bad thing as a lot of the natural material waste will be degraded and add to the soil by virtue of the bugs, etc, in the soil.

However when it comes to plastics materials, these are not natural materials and generally do not bio-degrade, consequently a number of the materials traditionally used have been developed to perform a task without consideration of what happens when they are thrown away. In fact a lot of these materials do not and are not capable of being degraded by living organisms in the soil. Therefore they will stay intact for potentially hundreds of years in the soil. This also applies to certain non-plastic synthetic materials such as detergents.

The materials that are selected for use in the manufacture of products or specialist components are selected on the basis of commercial as well as technical considerations. Unless the driving force in the selection of a material is technical the selection will be based on a purely commercial basis. Therefore a majority of materials are used because they are readily available and cheap.

Over recent years there has been an increase in the availability of bio-degradable materials. These are materials that will degrade over time or on the application of a certain trigger, such as placing in water, and these materials are available for uses across the board. The real problem with their take up for use is not with the small additional costs that may be associated with development for a particular application but with a lack of awareness of their availability and also of their suitability for the purpose.

It is these problems and issues that the present invention is concerned with and importantly to act as a valuable educational resource for teachers and students alike to demonstrate, test, study and draw conclusions, the processes involved in biodegrading, and if appropriate using control samples

In accordance with the present invention there is provided a kit to enable the bio-degradability of a material to be observed, the kit including:
at least one environmental vessel formed from a non biodegradable material having an opening that can be covered with a sealable lid for loading of the vessel, which vessel includes means so that the vessel can be sealed or ventilated if desired;
at least one sample of a material to be tested;

wherein the sample to be tested can be located in the vessel and tested under the influence of a particular environment, which environment may be ventilated if desired.

This invention can be used to test any material to show the biodegradability of the particular material. It is envisaged that this will generally be in the form of comparative tests where samples of a material in different environments or different materials in the same environment are undertaken.

The vessel may be filled may be sealed or ventilated as desired to create the particular environment creating material, for example, water, soil either acidic or alkali, compost, etc, and the sample located therein in the appropriate position for example, standing alone, or partially or fully immersed.

In a preferred embodiment the vessel comprises a lower section, which may be formed with transparent or translucent sides and a sealable lid.

A stand or shelf may be provided for inclusion in the vessel and also to provide means onto which a sample may be located. The stand may be provided with means to secure or properly locate a sample.

In one arrangement of the present invention the sealable lid includes at least one ventilation opening to allow the environment in the vessel to breathe. In one specific embodiment of the invention the lid is provided with inward spaced circumferentially extending slots cut into the lid and a cover piece is provided that can be rotated about a pivot mounting to the lid so that the extent the opening is open can be adjusted and varied. The cover piece may be provided with an upstanding member to regulate the rotational movement of the cover piece with respect to a particular slot.

In one example of the invention the sealable lid may also include a further opening which could be sealable and through which a sample or samples stick may be deployed.

The vessel is made from a material that will not degrade by exposure to the environment under test and is preferably an injection-moulded vessel with a push fit injection moulded lid.

The sealable lid of the vessel and other components may be formed from the same material or they may be formed from different materials chosen to fulfil a particular function.

The sealable lid of the vessel and other components may be formed from any suitable polymeric material, for example, polycarbonate, polyethylene, or polypropylene.

The samples suitable for use with the present invention may be any suitable shape, and could simply be deployed in the vessel, for example resting on the shelf or stand, or on the bottom of the vessel. Alternatively means may be provided for the deployment of the samples. In one example of the means for deployment there is provided a T-shaped or L-shaped stick member which when deployed a handle section of the member extends out of the vessel to enable handling of the sample.

In one particular example of the invention there is provided at least one sample holder suitable for holding a sample of material to be tested, wherein the sample holder includes a handle section, a window and first and second holding sections which holding sections can be located so as to secure the sample in the window and the sample holder with sample to be tested can be located in the vessel and tested under the influence of a particular environment and if desired the vessel is sealed.

In one arrangement the sample holder comprises an elongated shaft section with a bulbous head section that includes the handle section. The holding sections may be provided in the elongated section with at least one holding section being integrally formed with the head section and the other holding section being locatable with respect to the first holding section so that the windows of the holding sections are cooperatively arranged with respect to each other.

The sample holder may be formed as a single unit with a hinged section between and joining the holding sections. In one example the holding sections are formed with suitable means so that when the first and second holding sections are located in cooperating configuration a sample material disposed in the window is held in position in the sample holder.

The sample holder may be provided with means to secure the two holding sections with respect to one another when located to secure a sample in place for testing. Preferably, said means is to secure is releasable.

The sample holder may be formed from any suitable material and is preferably formed from a non-bio-degradable material. This is to enable the sample holder to be reused.

It is envisaged that the sample holder may be used to hold sample of a number of materials, for example a strips, so that they can be tested in the environmental conditions at the same time.

The invention may also include suitable carrying means to hold samples and which can be deployed and held by the holding sections of the sample holder. For example the carrying means may comprise a cage, capsule or clip type member.

The present invention also includes sample holders as described above and suitable for use with the above mentioned invention.

The invention also includes samples for use with the invention as described above.

The invention will now be described by way of example, with reference to the accompanying drawings in which:

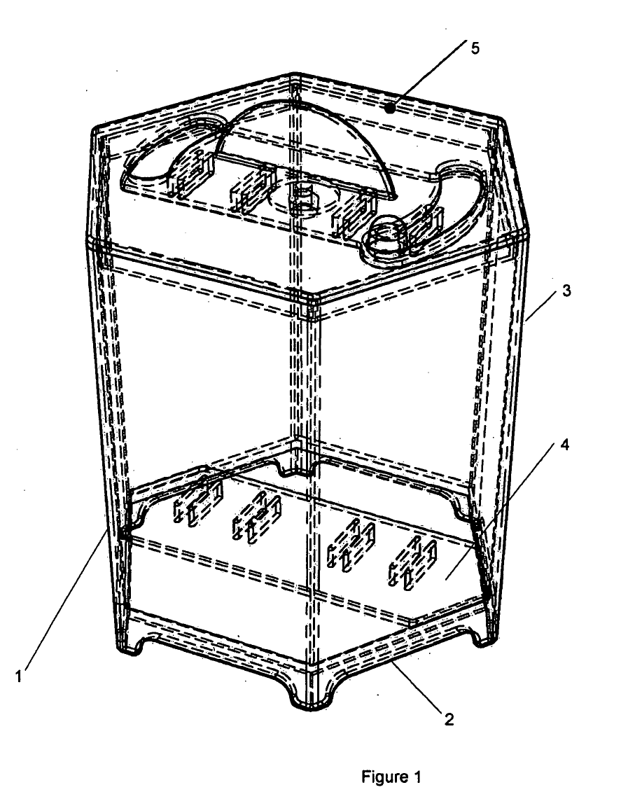

FIGS. 1 & 2 show a vessel and lid in accordance with the present invention;

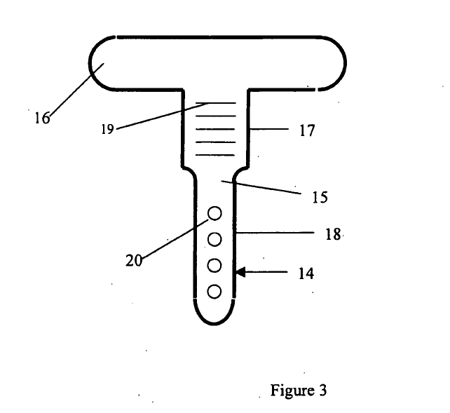

FIG. 3 shows a view of sample suitable for use with the present invention and

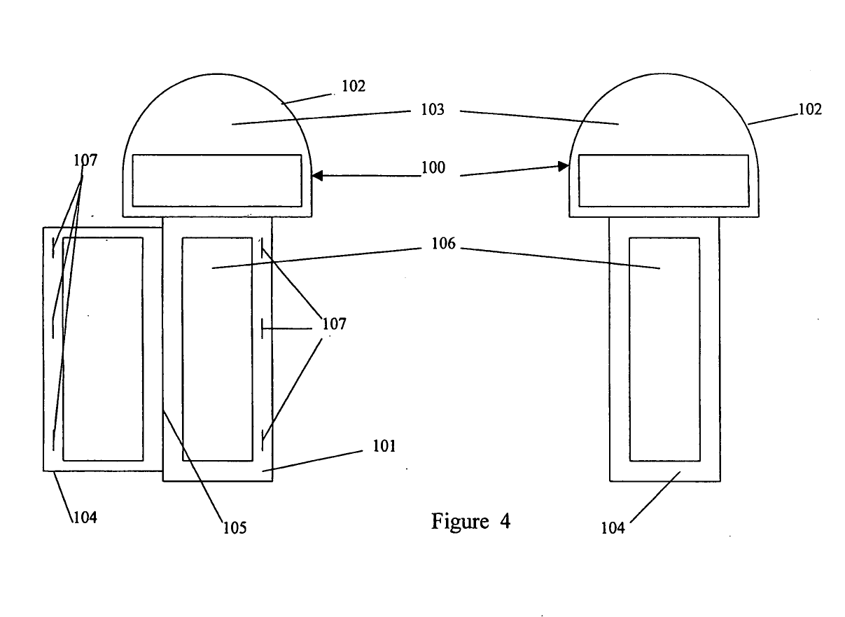

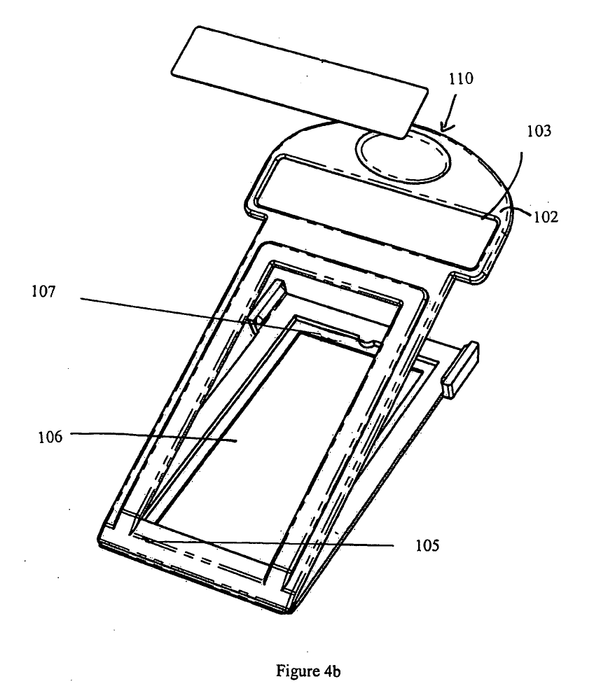

FIGS. 4 & 4a shows a sample holder suitable for use with the present invention: and

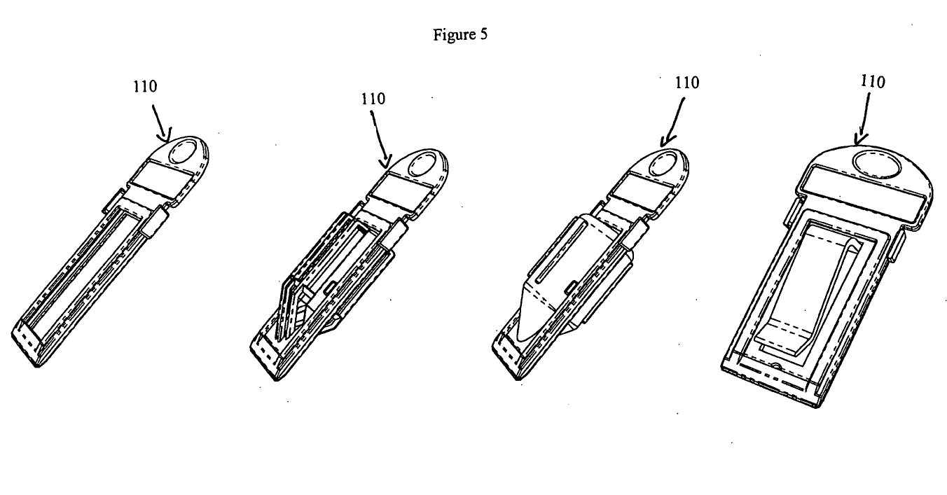

FIGS. 5a to 5d show various arrangements of the sample holder of FIG. 4.

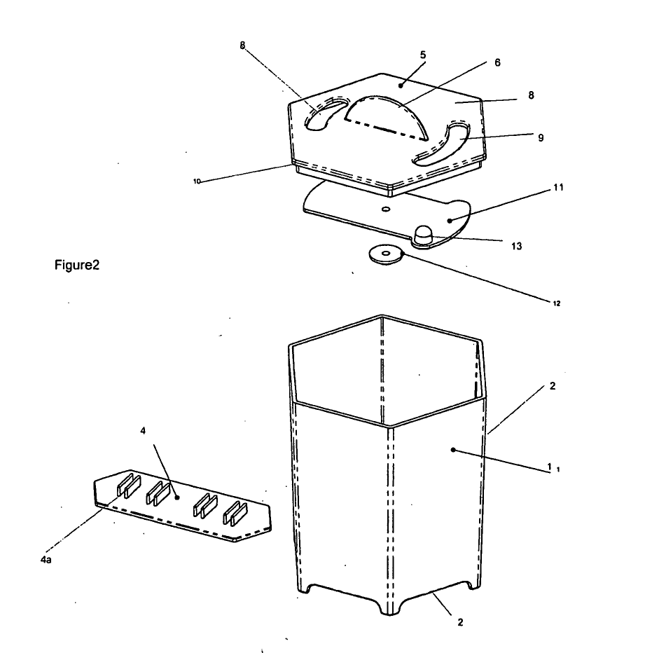

Referring to FIGS. 1 and 2 of the drawings, there is shown a vessel 1 with a lid 5 suitable for use with the present invention and which can act to seal the environment within the vessel.

The vessel 1 may be formed by injection moulding from, for example, polyethylene or polypropylene or polycarbonate and will be therefore be substantially non bio-degradable.

In the particular example shown the vessel is formed with a regular hexagon cross-section and is also substantially translucent to enable the observation of the inside of the vessel without removal of the lid 5.

The vessel comprises a base section 2 with an upstanding wall 3 extending there around so as a to form a pot.

A stand 4 of suitable non-biodegradable material is located in the vessel 1 and provides a platform on which an experimental sample may be placed. The stand 4 may be provided with retaining means 4a to help secure and fix a sample in position on the stand 4.

The lid 5 is formed with a flat upper surface 6 having a handle 7 and two arcuate slots 8 diametrically opposed and set lightly inward of the edge of the lid 5 and a downward circumferential rib 9. The rib 9 is set slightly inward of the periphery of the lid 5, and with the upper surface of the lid 5 defines a lip 10 at the periphery of the lid 5. A slot giving access to the vessel may also be provided in the upper surface of the lid 5.

A cover piece 11 is fitted via a pivot mount to the underside of the lid 5. The fitting may be via a simple pin and washer 12 arrangement. The cover piece 11 is sized and shaped to cover the arcuate slots 8 when in a particular orientation. The pivot mounting of the cover piece 11 to the lid 5 means that he cover piece can be rotated to expose and open as much of the slots 8 as is desired. A handle 12 may be provided on the cover piece 11 so that when the cover piece is fitted the handle 13 protrudes through one of the slots so that the cover piece can be easily rotated without removing the lid 5.

When the lid 5 is fitted to the vessel 1 the upper part of the vessel wall 3 locates against the lip 10 to secure the lid in the correct position on the vessel. In one arrangement they cooperatively engage to form a seal.

Now referring to FIG. 3 of the drawings there is shown a sample 14 suitable for use with the present invention. The sample shown is substantially T shaped having an elongate section 15 and a cross bar section 16 which forms the T. The samples may be formed from any material for testing in the kit of the present invention and may be formed in any suitable manner for example the samples can be manufactured by machining or by casting or by injection moulding.

The elongate section 15 of the sample 14 in the example shown is formed with an upper section 17 and a lower section 18. The upper section is formed with a greater width than the lower section and is also provided with horizontally extending ribs 19. The lower section 18 may be either smooth of also be provided with suitable adaptations to enhance the observation of the experiment. Typically adaptation of the lower section 18 may include provisions of through bores, indentations or nodular protrusions 20.

It is envisaged that the sample 14 may comprise a member having provision for inclusion of and observation of sample materials in the body of another supporting material.

Now referring to FIGS. 4 and 5 of the drawings there is shown an alternative sample holder 100 suitable for use with the present invention. The sample holder has a substantially T shape having an elongate section 101 and a head section 102.

The head section 102 includes a handle section 103 and provides means by which the sample holder 100 can be lifted and relocated.

The elongated section 101 comprises two holding sections 104 which are interconnected by a moulded hinge strip 105 running along the length of one of the edges. Each of the holding sections 104 include a frame like border with a central window 106. The holding sections are provided with tongue and slot engagement means 107 spaced along the opposing edges to the hinge strip 105 of the frame.

Further the inner surface of the holding section about the window 106 is provided with suitable engaging means to hold a suitably shaped sample in place within the window 106.

The holding sections 104 are designed so that when the one section is rotated about the hinge 105 over onto the other section the windows 106 in the sections cooperate to form a through window into which a suitably shaped sample may be fixed.

The samples may be formed from any material for testing in the kit of the present invention and may be formed in any suitable manner.

In the example of sample holder 100 illustrated in FIG. 4 of the drawings here the window 106 is of rectangular construction and therefore the sample will also have a rectangular construct.

In use a sample may be located in the sample holder 108 and one of the holding sections 104 is moved about the hinge 105 and the holding sections pushed together so that he the engagement means 107 engage and the sample is secured in location in the window 106.

The sample holder 100 may now be disposed in the environment of the vessel 1.

The vessel and sample may be observed over the period of the test and observations recorded.

The above illustrates an arrangement where the sample is directly held by the sample holder. However, in an alternative arrangement of the present invention there is provided a sample carrier 110 which can be located in the window in a similar fashion to that described for holding the sample directly.

FIG. 4a shows an alternative sample holder to that described above. The alternative is similar to that described above and like numerals have been used to identify like components. The sample holder of FIG. 4a differs in that the hinge section 105 extends along the lower edge rather than a side edge.

The carrier 110 comprises an injection moulded component which provides a secure space for the location and holding of the sample. FIGS. 5a to 5d show several sample holders with different carriers 110 in place in the holder.

FIG. 5a shows the basic sample holder 100.

FIG. 5b shows a sample holder 100 with a cage like carrier 110 in place.

FIG. 5c shows a sample holder 100 with capsule like carrier 110 in place.

FIG. 5d shows a sample holder 100 with a clip like carrier 110 in place.

The carrier is generally formed from a transparent or translucent plastic material.

1. A kit to enable the bio-degradability of a material to be observed, the kit including:
at least one environmental vessel formed from a non bio-degradable material having an opening that can be covered with a sealable lid for loading of the vessel, which vessel includes means so that the vessel can be sealed or ventilated if desired;
at least one sample of a material to be tested;
wherein the sample to be tested can be located in the vessel and tested under the influence of a particular environment, which environment may be ventilated if desired.

2. A kit as claimed in claim 1 wherein the vessel comprises a lower section, formed with transparent or translucent sides.

3. A kit as claimed in claim 1 wherein a stand or shelf is provided for inclusion in the vessel to provide means onto which a sample may be located.

4. A kit as claimed in claim 3 wherein the stand is provided with means to secure or properly locate a sample.

5. A kit as claimed in claim 1 wherein the lid includes at least one ventilation opening to allow the environment in the vessel to breathe.

6. A kit as claimed in claim 5 wherein the lid is provided with inward spaced circumferentially extending slots cut into the lid and a cover piece provided that can be rotated about a pivot mounting to the lid so that the extent the opening is open can be adjusted and varied.

7. A kit as claimed in claim 6 wherein the cover piece is provided with an upstanding member to regulate the rotational movement of the cover piece with respect to a particular slot.

8. A kit as claimed in claim 1 wherein the lid includes an opening which can be sealable and through which a sample or samples stick can be deployed.

9. A kit as claimed in claim 1 wherein the vessel is made from a material that will not degrade by exposure to the environment under test.

10. A kit as claimed in claim 1 wherein the vessel is injection-moulded with a push fit injection moulded lid.

11. A kit as claimed in claim 1 wherein the lid of the vessel and other components may be formed from the same material.

12. A kit as claimed in claim 1 wherein the lid of the vessel and other components are formed from different materials chosen to fulfil a particular function.

13. A kit as claimed in claim 1 wherein the sealable lid of the vessel and other components may be formed from any suitable polymeric material.

14. A kit as claimed in claim 1 wherein means is provided for the deployment of the samples.

15. A kit as claimed in claim 14 wherein the means for deployment is a T-shaped or L-shaped stick member which when deployed includes a handle section that extends out of the vessel to enable handling of the sample.

16. A kit as claimed in claim 1 wherein there is provided at least one sample holder suitable for holding a sample of material to be tested, wherein the sample holder includes a handle section, a window and first and second holding sections which holding sections can be located so as to secure the sample in the window and the sample holder with sample to be tested can be located in the vessel and tested under the influence of a particular environment and if desired the vessel is sealed.

17. A kit as claimed in claim 16 wherein the sample holder comprises an elongated shaft section with a bulbous head section that includes the handle section.

18. A kit as claimed in claim 17 wherein the holding sections are provided in the elongated section with at least one holding section being integrally formed with the head section and the other holding section being locatable with respect to the first holding section so that the windows of the holding sections are cooperatively arranged with respect to each other.

19. A kit as claimed in claim 18 wherein the sample holder is formed as a single unit with a hinged section between and joining the holding sections.

20. A kit as claimed in claim 16, wherein there is also provided carrying means to hold samples and which can be deployed and held by the holding sections of the sample holder.
